(19) United States
(12) Patent Application Publication
(10) Pub. No.: US 2026/0040146 A1
(43) Pub. Date: Feb. 5, 2026

(54) ARTIFICIAL INTELLIGENCE NATIVE CONFIGURED GRANT TIMERS

(71) Applicant: QUALCOMM Incorporated, San Diego, CA (US)

(72) Inventors: Diana MAAMARI, San Diego, CA (US); Mickael MONDET, Louannec (FR); Prasada Veera Reddy KADIRI, San Diego, CA (US); Ozcan OZTURK, San Diego, CA (US); Hyun Yong LEE, San Diego, CA (US)

(21) Appl. No.: 18/789,051

(22) Filed: Jul. 30, 2024

(51) Int. Cl. H04W 28/18; H04L 5/00; H04W 28/02; H04W 72/54

(52) U.S. Cl. CPC H04W 28/18; H04L 5/0048; H04L 5/0055; H04W 28/0215; H04W 72/54

(57) ABSTRACT

Methods, systems, and devices for wireless communications are described. A machine learning model implemented at a user equipment (UE) may be used to determine recommendation information associated with a configured grant. The recommendation information may be a value for a timer, such as a configured grant timer or a configured grant retransmission timer. The UE may signal the recommendation information to a network entity. The network entity may adjust configuration information for a configured grant to indicate a configured grant timer value that is based on the recommendation information. The network entity may transmit the adjusted configured information to the UE. During a configured grant period associated with the configured grant, the UE may use the CG timer value that is based on the recommendation information when transmitting or retransmitting an uplink message.

### FIELD OF TECHNOLOGY

The following relates to wireless communications, including artificial intelligence (AI) native configured grant timers.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a message that indicates recommendation information for one or more configured grants for the UE, receiving configuration information for the one or more configured grants, where the one or more configured grants indicate periodic uplink resources for one or more respective configured grant periods, where the periodic uplink resources include transmission occasions allocated for uplink transmissions, and where the configuration information indicates at least one configured grant timer value that is associated with at least one configured grant period of the one or more respective configured grant periods and that is based on the recommendation information, initiating a first configured grant timer based on transmission of an uplink message during a first transmission occasion of a set of transmission occasions within a first configured grant period of the at least one configured grant period, where a duration of the first configured grant timer is based on a first configured grant timer value associated with the at least one configured grant timer value, and transmitting, based on expiration of the first configured grant timer, a retransmission of the uplink message in a subsequent transmission occasion of the set of transmission occasions.

A UE for wireless communications is described. The UE may include one or more memories storing processor executable code, and one or more processors coupled with the one or more memories. The one or more processors may individually or collectively be operable to execute the code to cause the UE to transmit a message that indicates recommendation information for one or more configured grants for the UE, receive configuration information for the one or more configured grants, where the one or more configured grants indicate periodic uplink resources for one or more respective configured grant periods, where the periodic uplink resources include transmission occasions allocated for uplink transmissions, and where the configuration information indicates at least one configured grant timer value that is associated with at least one configured grant period of the one or more respective configured grant periods and that is based on the recommendation information, initiate a first configured grant timer based on transmission of an uplink message during a first transmission occasion of a set of transmission occasions within a first configured grant period of the at least one configured grant period, where a duration of the first configured grant timer is based on a first configured grant timer value associated with the at least one configured grant timer value, and transmit, based on expiration of the first configured grant timer, a retransmission of the uplink message in a subsequent transmission occasion of the set of transmission occasions.

Another UE for wireless communications is described. The UE may include means for transmitting a message that indicates recommendation information for one or more configured grants for the UE, means for receiving configuration information for the one or more configured grants, where the one or more configured grants indicate periodic uplink resources for one or more respective configured grant periods, where the periodic uplink resources include transmission occasions allocated for uplink transmissions, and where the configuration information indicates at least one configured grant timer value that is associated with at least one configured grant period of the one or more respective configured grant periods and that is based on the recommendation information, means for initiating a first configured grant timer based on transmission of an uplink message during a first transmission occasion of a set of transmission occasions within a first configured grant period of the at least one configured grant period, where a duration of the first configured grant timer is based on a first configured grant timer value associated with the at least one configured grant timer value, and means for transmitting, based on expiration of the first configured grant timer, a retransmission of the uplink message in a subsequent transmission occasion of the set of transmission occasions.

A non-transitory computer-readable medium storing code for wireless communications is described. The code may include instructions executable by one or more processors to transmit a message that indicates recommendation information for one or more configured grants for the UE, receive configuration information for the one or more configured grants, where the one or more configured grants indicate periodic uplink resources for one or more respective configured grant periods, where the periodic uplink resources include transmission occasions allocated for uplink transmissions, and where the configuration information indicates at least one configured grant timer value that is associated with at least one configured grant period of the one or more respective configured grant periods and that is based on the recommendation information, initiate a first configured grant timer based on transmission of an uplink message during a first transmission occasion of a set of transmission occasions within a first configured grant period of the at least one configured grant period, where a duration of the first configured grant timer is based on a first configured grant timer value associated with the at least one configured grant timer value, and transmit, based on expiration of the first configured grant timer, a retransmission of the uplink message in a subsequent transmission occasion of the set of transmission occasions.

Some examples of the method, user equipment (UEs), and non-transitory computer-readable medium described herein may further include operations, features, means, or instructions for transmitting a capability message indicating a capability of the UE to recommend, in the recommendation information, an adjustment to a configured grant timer parameter.

In some examples of the method, user equipment (UEs), and non-transitory computer-readable medium described herein, transmitting the message may include operations, features, means, or instructions for transmitting the message via uplink assistance information, uplink control information, or a medium access control-control element (MAC-CE).

Some examples of the method, user equipment (UEs), and non-transitory computer-readable medium described herein may further include operations, features, means, or instructions for receiving a second message that indicates a request for a recommendation for adjustment to a configured grant timer parameter or indicates a capability of a network entity to adjust a configured grant timer parameter based on a UE recommendation, where transmitting the message includes and transmitting the message based on receiving the second message.

Some examples of the method, user equipment (UEs), and non-transitory computer-readable medium described herein may further include operations, features, means, or instructions for receiving an acknowledgement message of successful receipt of the recommendation information.

In some examples of the method, user equipment (UEs), and non-transitory computer-readable medium described herein, the at least one configured grant timer value includes a maximum configured grant timer value and a minimum timer value and the method, apparatuses, and non-transitory computer-readable medium may include further operations, features, means, or instructions for selecting the first configured grant timer value, where the first configured grant timer value may be less than or equal to the maximum configured grant timer value and greater than or equal to the minimum timer value and transmitting a second message indicating second recommendation information, where the second recommendation information includes the first configured grant timer value.

Some examples of the method, user equipment (UEs), and non-transitory computer-readable medium described herein may further include operations, features, means, or instructions for transmitting a second message including one or more indications of one or more performance indicators associated with the UE.

Some examples of the method, user equipment (UEs), and non-transitory computer-readable medium described herein may further include operations, features, means, or instructions for transmitting, based on one or more performance indicators failing to satisfy a performance threshold, a second message indicating second recommendation information, where the second recommendation information includes one or more default configured grant timer parameter values.

In some examples of the method, user equipment (UEs), and non-transitory computer-readable medium described herein, transmitting the message may include operations, features, means, or instructions for transmitting the message based on detecting that a performance indicator fails to satisfy a performance threshold.

Some examples of the method, user equipment (UEs), and non-transitory computer-readable medium described herein may further include operations, features, means, or instructions for generating, using a machine learning model and based on one or more performance indicators associated with the UE, the recommendation information.

In some examples of the method, user equipment (UEs), and non-transitory computer-readable medium described herein, the configuration information indicates a prohibit timer value indicating a time duration to delay a subsequent request for adjustment to a configured grant timer parameter.

In some examples of the method, user equipment (UEs), and non-transitory computer-readable medium described herein, the recommendation information includes one or more configured grant timer parameter values and the message includes indications of which of the one or more configured grant timer parameter values may be associated with which of the one or more configured grants.

In some examples of the method, user equipment (UEs), and non-transitory computer-readable medium described herein, the recommendation information includes an indication that a configured grant timer for an associated configured grant may be to be disabled, an indication of whether to enable or disable both a configured grant timer for an associated configured grant and a hybrid automatic repeat request (HARQ) retransmission timer, or a combination thereof.

In some examples of the method, user equipment (UEs), and non-transitory computer-readable medium described herein, the message includes an indication of a quantity of HARQ processes for which at least one configured grant timer parameter value indicated by the recommendation information may be to be maintained.

In some examples of the method, user equipment (UEs), and non-transitory computer-readable medium described herein, the subsequent transmission occasion aligns with the expiration of the first configured grant timer.

In some examples of the method, user equipment (UEs), and non-transitory computer-readable medium described herein, the first configured grant timer includes a configured grant timer or a configured grant retransmission timer.

A method for wireless communications by a network entity is described. The method may include receiving a message indicating recommendation information for one or more configured grants for a UE, generating configuration information for the one or more configured grants, where the one or more configured grants indicate periodic uplink resources for one or more respective configured grant periods, and where the periodic uplink resources include transmission occasions allocated for uplink transmissions, adjusting, based on the recommendation information, at least one configured grant timer value of at least one respective configured grant timer, where the at least one respective configured grant timer is associated with at least one configured grant of the one or more configured grants, and transmitting the configuration information for the one or more configured grants.

A network entity for wireless communications is described. The network entity may include one or more memories storing processor executable code, and one or more processors coupled with the one or more memories. The one or more processors may individually or collectively be operable to execute the code to cause the network entity to receive a message indicating recommendation information for one or more configured grants for a UE, generate configuration information for the one or more configured grants, where the one or more configured grants indicate periodic uplink resources for one or more respective configured grant periods, and where the periodic uplink resources include transmission occasions allocated for uplink transmissions, adjusting, base at least in part on the recommendation information, at least one configured grant timer value of at least one respective configured grant timer, where the at least one respective configured grant timer is associated with at least one configured grant of the one or more configured grants, and transmit the configuration information for the one or more configured grants.

Another network entity for wireless communications is described. The network entity may include means for receiving a message indicating recommendation information for one or more configured grants for a UE, means for generating configuration information for the one or more configured grants, where the one or more configured grants indicate periodic uplink resources for one or more respective configured grant periods, and where the periodic uplink resources include transmission occasions allocated for uplink transmissions, means for adjusting, based on the recommendation information, at least one configured grant timer value of at least one respective configured grant timer, where the at least one respective configured grant timer is associated with at least one configured grant of the one or more configured grants, and means for transmitting the configuration information for the one or more configured grants.

A non-transitory computer-readable medium storing code for wireless communications is described. The code may include instructions executable by one or more processors to receive a message indicating recommendation information for one or more configured grants for a UE, generate configuration information for the one or more configured grants, where the one or more configured grants indicate periodic uplink resources for one or more respective configured grant periods, and where the periodic uplink resources include transmission occasions allocated for uplink transmissions, adjusting, base at least in part on the recommendation information, at least one configured grant timer value of at least one respective configured grant timer, where the at least one respective configured grant timer is associated with at least one configured grant of the one or more configured grants, and transmit the configuration information for the one or more configured grants.

Some examples of the method, network entities, and non-transitory computer-readable medium described herein may further include operations, features, means, or instructions for transmitting a capability message indicating a capability of the network entity to adjust a configured grant timer parameter based on a UE recommendation.

In some examples of the method, network entities, and non-transitory computer-readable medium described herein, receiving the message may include operations, features, means, or instructions for receiving the message via uplink assistance information, uplink control information, or a medium access control-control element (MAC-CE).

In some examples of the method, network entities, and non-transitory computer-readable medium described herein, receiving the message may include operations, features, means, or instructions for transmitting a second message that indicates a request for a recommendation for adjustment to a configured grant timer parameter or indicating a capability to adjust a configured grant timer parameter based on a UE recommendation, where receiving the message includes and receiving the message based on transmitting the second message.

Some examples of the method, network entities, and non-transitory computer-readable medium described herein may further include operations, features, means, or instructions for transmitting, based on receiving the message indicating the recommendation information, an acknowledgement message of successful receipt of the recommendation information.

In some examples of the method, network entities, and non-transitory computer-readable medium described herein, the at least one configured grant timer value includes a maximum configured grant timer value and a minimum timer value and the method, apparatuses, and non-transitory computer-readable medium may include further operations, features, means, or instructions for receiving a second message indicating second recommendation information, where the second recommendation information includes a configured grant timer parameter value that may be less than or equal to the maximum configured grant timer value and greater than or equal to the minimum timer value.

Some examples of the method, network entities, and non-transitory computer-readable medium described herein may further include operations, features, means, or instructions for receiving a second message including one or more indications of one or more performance indicators associated with the UE and adjusting, based on at least one of the one or more performance indicators failing to satisfy a performance threshold, a configured grant timer value of at least one configured grant timer associated with at least one of the one or more configured grants to a default configured grant timer value.

In some examples of the method, network entities, and non-transitory computer-readable medium described herein, the configuration information indicates a prohibit timer value indicating a time duration for the UE to delay transmission of a subsequent request for adjustment to a configured grant timer parameter.

In some examples of the method, network entities, and non-transitory computer-readable medium described herein, the recommendation information includes one or more configured grant timer parameter values and the message includes indications of which of the one or more configured grant timer parameter values may be associated with which of the one or more configured grants.

In some examples of the method, network entities, and non-transitory computer-readable medium described herein, the recommendation information includes an indication that a configured grant timer for an associated configured grant may be to be disabled, an indication of whether to enable or disable both a configured grant timer for an associated configured grant and an HARQ retransmission timer, or a combination thereof.

In some examples of the method, network entities, and non-transitory computer-readable medium described herein, the message includes an indication of a quantity of HARQ processes for which at least one configured grant timer parameter value indicated by the recommendation information may be to be maintained.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports AI native configured grant timers in accordance with one or more aspects of the present disclosure.

FIG. 2 shows an example of a portion of a wireless communications system that supports AI native configured grant timers in accordance with one or more aspects of the present disclosure.

FIG. 3 shows an example of a configured grant transmission scheme that supports AI native configured grant timers in accordance with one or more aspects of the present disclosure.

FIG. 4 shows an example of a process flow that supports AI native configured grant timers in accordance with one or more aspects of the present disclosure.

FIGS. 5 and 6 show block diagrams of devices that support AI native configured grant timers in accordance with one or more aspects of the present disclosure.

FIG. 7 shows a block diagram of a communications manager that supports AI native configured grant timers in accordance with one or more aspects of the present disclosure.

FIG. 8 shows a diagram of a system including a device that supports AI native configured grant timers in accordance with one or more aspects of the present disclosure.

FIGS. 9 and 10 show block diagrams of devices that support AI native configured grant timers in accordance with one or more aspects of the present disclosure.

FIG. 11 shows a block diagram of a communications manager that supports AI native configured grant timers in accordance with one or more aspects of the present disclosure.

FIG. 12 shows a diagram of a system including a device that supports AI native configured grant timers in accordance with one or more aspects of the present disclosure.

FIGS. 13 and 14 show flowcharts illustrating methods that support AI native configured grant timers in accordance with one or more aspects of the present disclosure.

### DETAILED DESCRIPTION

In some wireless communications systems, periodic communications between devices, such as between a network entity and a user equipment (UE), may be used to exchange information over a period of time. For example, the UE may transmit data to the network entity according to a set schedule, which may result in communications according to a set periodicity. In some cases, to help reduce signaling overhead and latency associated with separately signaling a resource grant for each instance of such periodic transmission, the network entity may configure the UE with an uplink grant that may cover multiple uplink transmission occasions. In some cases, such configuration may be referred to as a configured grant or a semi-persistent scheduling (SPS) configuration. The configured grants may provide the UE with periodic resources for uplink transmissions from a UE to a network entity. Additionally or alternatively, the configured grants may additionally provide the UE with periodic resources for retransmissions of uplink data, such as when an initial uplink transmission is not successfully received or decoded by the network entity. The UE may then use the resources provided by the configured grant to transmit and retransmit uplink data on multiple and periodic occasions. In some cases, however, it may be beneficial to adjust the periodicity (e.g., the frequency) of such occasions for transmitting or retransmitting periodic uplink data based on network conditions, application parameters, operating and performance targets, or the like.

Aspects of the disclosure are initially described in the context of wireless communications systems. Aspects of the disclosure are further illustrated by and described with reference to apparatus diagrams, system diagrams, and flowcharts that relate to AI native configured grant timers.

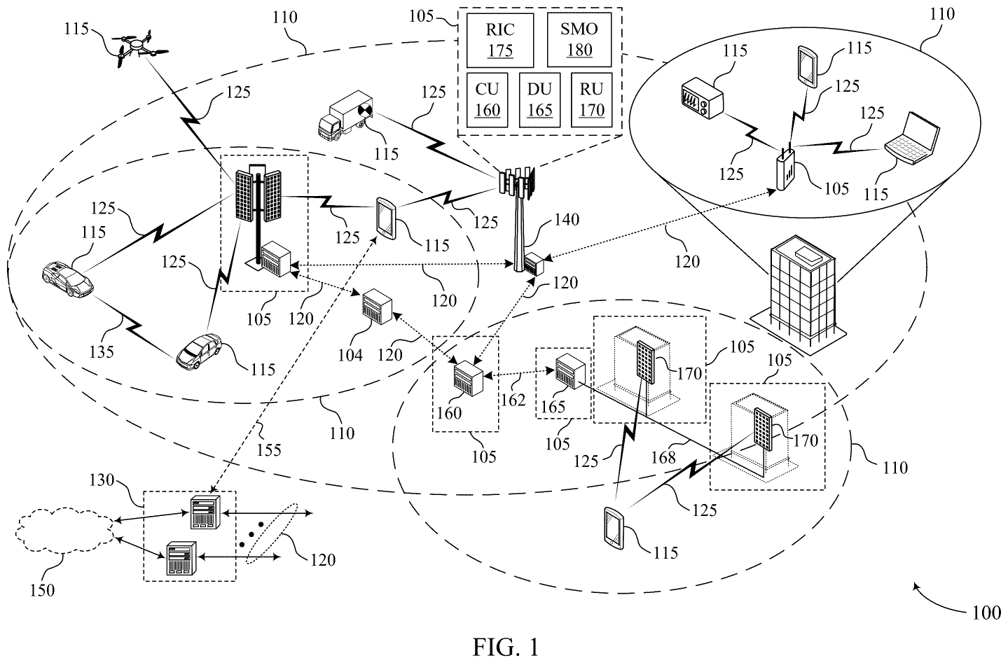

FIG. 1 shows an example of a wireless communications system 100 that supports AI native configured grant timers in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In accordance with aspects described herein, a UE 115 may be configured to support the signaling of recommendation information to a network entity 105. The recommendation information may include recommended timer values to be associated with one or more configured grants. The recommended timer values may be for a configured grant timer, a configured grant retransmission timer, or both. The UE 115 may signal the recommendation information to the network entity 105, and the network entity 105 may adjust a configured grant timer or a configured grant retransmission timer associated with one or more configured grants in accordance with the recommendation information. The network entity 105 may include the adjusted configured grant timer value, the adjusted configured grant retransmission timer value, or both in configuration information associated with the one or more configured grant. The network entity 105 may signal the configured grant configuration information to the UE 115. The UE 115 may, thereafter, use the adjusted configured grant timer value, the adjusted configured grant retransmission timer value, or both for transmitting (or retransmitting) uplink data to the network entity 105.

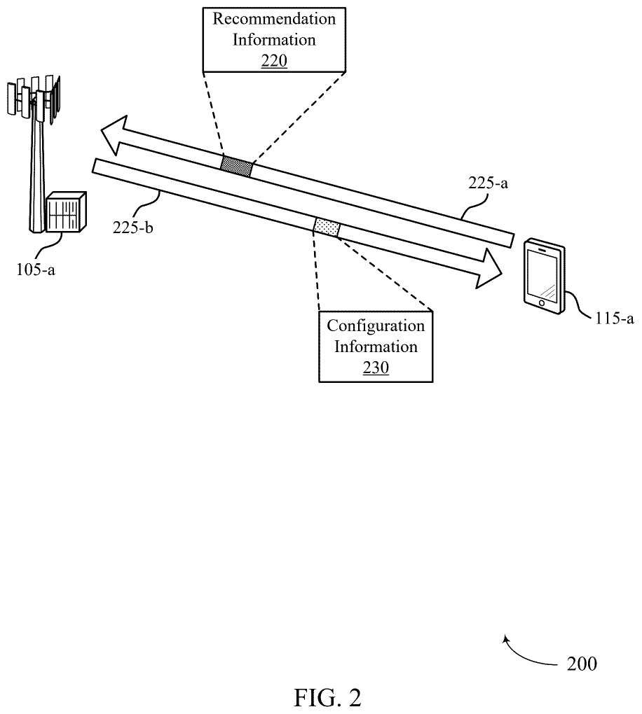

FIG. 2 shows an example of a portion of a wireless communications system 200 that supports AI native configured grant timers in accordance with one or more aspects of the present disclosure. The wireless communications system 200 may include a network entity 105-a and a UE 115-a, which may be examples of network entities 105 and UEs 115, respectively, described herein with reference to FIG. 1. The network entity 105-a and UE 115-a may communicate using communication links (e.g., a Uu link) over which the UE 115-a may transmit uplink communications, such as recommendation information 220, to the network entity 105-a, via an uplink channel 225-a; and which the network entity 105-a may transmit downlink communications, such as configuration information 230, to the UE 115-a, via a downlink channel 225-b.

In some wireless communications systems, periodic communications between devices, such as between the network entity 105-a and the UE 115-a, may be used to exchange information over a period of time. For example, the UE 115-a may transmit data to the network entity 105-a according to a set schedule, which may necessitate communications according to a set periodicity. In some cases, in order to help reduce signaling overhead and latency associated with separately signaling a resource grant for each instance of such periodic transmission, the network entity 105-a may provide the UE 115-a with configuration information that may be used to configure the UE 115-a with one or more configured grants that each cover multiple uplink transmission occasions. In some cases, the configuration information (e.g., a configured grant configuration) may be provided by the network entity 105-a to the UE 115-a via RRC configuration.

The configuration information may provide an indication of one or more configured grants, which may provide the UE 115-a with periodic resources for uplink transmissions and retransmissions from the UE 115-a to the network entity 105-a. The configuration information may also provide an indication of one or more timers associated with each configured grant configuration. For instance, the configuration information may provide an indication of a configured grant timer, a configured grant retransmission timer, or both that may be maintained at a hybrid automatic repeat request (HARQ) process level. The configured grant timer and configured grant retransmission timer may be used to control the scheduling and allocation of configured grant resources for transmission or retransmission of uplink data during a given HARQ process.

The configured grant timer may be initiated when the UE 115-a transmits uplink data to the network entity 105-a. The duration of the configured grant timer may be the duration of the configured grant period. Accordingly, the UE 115-a may use configured grant resources to transmit the uplink data while the configured grant timer is active and may cease using the configured grant resources after expiration of a duration of the configured grant timer. For instance, when the configured grant period ends and the configured grant timer expires, the configured grant may no longer be valid (e.g., there may be no additional pre-allocated resources associated with the configured grant). The UE 115-a may then wait for a next opportunity (such as a next configured grant uplink transmission occasion associated with a second configured grant provided in the configuration information or requested by the UE 115-a) to transmit additional uplink data to the network entity 105-a.

The configured grant retransmission timer may run (e.g., be active) while the configured grant timer is running for a given HARQ process. The configured grant retransmission timer may be initiated by the UE 115-a if, after uplink data is transmitted to the network entity 105-a, an acknowledgement (ACK) message is not received from the network entity 105-a within a specified period of time or if a negative acknowledgement (NACK) message is received from the network entity 105-a. After expiration of a duration of the configured grant retransmission timer, the UE 115-a may retransmit the uplink message during the next configured grant uplink retransmission occasion using configured grant resources (e.g., the UE 115-a may be restricted from autonomously retransmitting uplink data on a configured grant resource for the HARQ process while the configured grant retransmission timer for the HARQ process is running). In some cases, the expiration of the configured grant retransmission timer may align or substantially align with the next configured grant uplink retransmission occasion. In some cases, a periodicity associated with the configured grant retransmission timer may be shorter than a periodicity associated with the configured grant timer (e.g., there may be multiple opportunities configured for retransmission of uplink data while the configured grant timer is running).

Such configured grants may be useful in latency-sensitive applications, such as extended reality (XR) multimedia and cloud computing (e.g., augmented reality (AR) glasses, virtual reality (VR) head-mounted display (HMD), cloud gaming, cloud AI, or the like). Such applications may have strict performance targets, including data rate, latency, and power consumption and may, therefore, benefit from the predictability and reduced delay associated with usage of pre-allocated periodic resources provided by configured grants.

In some cases, however, it may be beneficial for a periodicity associated with such periodic resources to be adjusted. That is, it may be beneficial for the periodicity (e.g., a frequency) of the configured grant uplink transmission occasions for transmitting or retransmitting uplink data to be adjusted based on network conditions, application requirements, UE behavior, or the like. For example, the UE 115-a may experience an increase in uplink latency (e.g., a latency increase above a threshold), and the UE 115-a may benefit from more frequent opportunities to transmit or retransmit uplink data. Ideally the configured grant retransmission timer might be configured with a shorter periodicity when the UE 115-a is experiencing higher latencies, and with a longer periodicity when uplink delay is more relaxed (e.g., when the UE 115-a is experiencing lower latencies). However, RRC configuration, typically used to provide the configured grant confirmation, might not provide such flexibility. Moreover, the network entity 105-a may be unaware of conditions at the UE 115-a and, therefore, might not be aware that adjustments to configurated grant timer values may be beneficial.

In accordance with aspects described herein, the UE 115-a may be configured with a capability to signal to the network entity 105-a recommendation information 220 associated with one or more configured grants. The recommendation information 220 may include recommended configured grant timer values, configured grant retransmission timer values, or both to be associated with one or more configured grants (e.g., configured grant configurations). The recommendation information 220 (e.g., the recommended timer values) may be based on knowledge of the UE 115-a of current conditions at the UE 115-a. In some cases, the UE 115-a may use an AI model to determine the recommendation information 220 based on key performance indicators (KPIs) (e.g., user plane traffic (UPT), statistical experienced latencies, packet error rate (PER)) associated with or measured at the UE 115-a.

The UE 115-a may transmit, and the network entity 105-a may receive, the recommendation information 220. After receiving the recommendation information 220, the network entity 105-a may determine whether to adjust, in accordance with the recommendation information 220, a configured grant timer, a configured grant retransmission timer, or both associated with one or more configured grant configurations. If the network entity 105-a determines to adjust a configured grant timer, a configured grant retransmission timer, or both associated with one or more configured grant configurations, the network entity 105-a may include the adjusted configured grant timer value, the adjusted configured grant retransmission timer value, or both in configured grant configuration information 230 to be signaled to the UE 115-a.

The network entity 105-a may transmit, and the UE 115-a may receive, the configured grant configuration information 230, including the adjusted configured grant timer value, the adjusted configured grant retransmission timer value, or both. The UE 115-a may, thereafter, use the adjusted configured grant timer value, the adjusted configured grant retransmission timer value, or both when transmitting or retransmitting uplink data to the network entity 105-a.

Such features may allow the UE 115-a the flexibility to assist the network entity 105 in adjusting a configured grant timer or a configured grant retransmission timer for one or more configured grants based on conditions at the UE 115-a. Further, if the network entity 105-a is aware that the UE 115-a wants to adjust, such as to extend, a periodicity associated with a configured grant timer, a configured grant retransmission timer, or both, the network entity 105-a may release resources that would have otherwise been allocated to the UE 115-a and may allocate the released resources to other UEs 115, thereby improving overall network capacity.

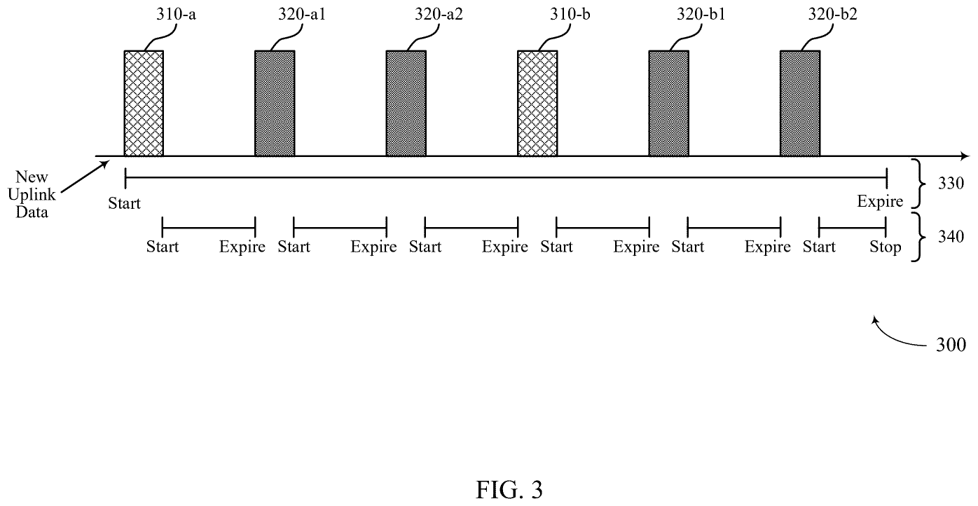

FIG. 3 shows an example of a configured grant transmission scheme 300 that supports AI native configured grant timers in accordance with one or more aspects of the present disclosure. In some examples, the transmission scheme 300 may implement or be implemented by aspects of the wireless communications system 100 or the wireless communications system 200, as described with reference to FIGS. 1 and 2, respectively. For example, the transmission schemes 300 may illustrate a scheme for transmitting uplink data from a UE, such as UE 115-a, to a network entity, such as network entity 105-a, which may be examples of corresponding devices described with reference to FIGS. 1 and 2, respectively. The transmission scheme 300 may be associated with a configuration of configured grant resources, such as configured grant transmission occasions 310 (e.g., configured grant transmission occasions 310-a and 310-b) and configured grant retransmission occasions 320 (e.g., a configured grant retransmission occasions 320-a1, 320-a2, 320-b1, and 320-b2), for use in transmitting uplink data from the UE 115-a to the network entity 105-a.

In accordance with aspects described herein, the network entity 105-a may configure the UE 115-a with one or more configured grants that provide the UE 115-a with periodic, pre-allocated resources for uplink transmissions for a period of time. For example, the network entity 105-a may transmit, to the UE 115-a, configuration information, such as configured grant configuration information. The configured grant configuration information may include information (e.g., one or more parameters) associated with a configured grant for uplink transmissions from the UE 115-a to the network entity 105-a.

For instance, the configured grant configuration information may include indications of configured grant resources, e.g., time and frequency domain resource allocations for uplink transmissions or retransmissions during a period in which the configured grant is valid. The indications of the time and frequency domain resource allocations may be indications of configured grant transmission occasions 310 (e.g., configured grant transmission occasions 310-a and 310-b) and configured grant retransmission occasions 320 (e.g., configured grant retransmission occasions 320-a1, 320-a2, 320-b1, and 320-b2). For instance, the configured grant configuration information may indicate one or more periodic transmission opportunities for the UE 115-a to transmit uplink data, such as a first configured grant transmission occasion 310-a and a second configured grant transmission occasion 310-b. Each of the configured grant transmission occasions 310 (e.g., the first configured grant transmission occasion 310-a and the second configured grant transmission occasion 310-b) may be associated with its own HARQ process and configured grant resources may be provided for retransmission of uplink data transmitted during a given HARQ process. Accordingly, the configured grant configuration information may also indicate one or more periodic retransmission opportunities for the UE 115-a to retransmit uplink data transmitted during one of the configured grant transmission occasions 310. For instance, the configured grant configuration information may indicate a first configured grant retransmission occasion 320-a1 and a second configured grant retransmission occasion 320-a2 for retransmitting uplink data transmitted during a first HARQ process, such as during the first configured grant transmission occasion 310-a. The configured grant configuration information may further indicate a third configured grant retransmission occasion 320-b1 and a fourth configured grant retransmission occasion 320-b2 for retransmitting uplink data transmitted during a second HARQ process, such as during the second configured grant transmission occasion 310-b.

The configured grant configuration may additionally include an indication of a periodicity associated with the configured grant resources. The periodicity may represent the interval at which the configured grant resources are allocated to the UE 115-a, e.g., a frequency of opportunities for the UE 115-a to transmit uplink communications. For instance, configuration information may indicate a periodicity of 30 milliseconds (ms), such that the UE 115-a may have an opportunity to transmit uplink data every 30 ms (e.g., via configured grant transmission occasions 310).

The configured grant configuration information may additionally include an indication of a duration of the configured grant period. The configured grant period may be the time period during which the configured grant is valid (e.g., the period during which the pre-allocated resources may be available). In some cases, a value for a duration of a configured grant timer 330 may be provided, and the configured grant timer value may be the duration of the configured grant period.

The configured grant configuration information may additionally include an indication of a value for a duration of a configured grant retransmission timer 340. The configured grant retransmission timer duration may be a period of time for which the UE 115-a may be restricted from retransmitting an uplink transmission. The initial value of the configured grant retransmission timer may be in multiples of the periodicity (e.g., every 10 ms), such that there may be more transmission opportunities (e.g., configured grant retransmission occasions 320) to retransmit uplink data than transmission opportunities (e.g., configured grant transmission occasions 310) to initially transmit the uplink data. An expiration of the configured grant retransmission timer 340 may align with a start of a configured grant retransmission occasion 320. Accordingly, when the configured grant retransmission timer 340 expires, the UE 115-a may have an opportunity to retransmit the uplink data in a next configured grant retransmission occasion 320. The configured grant retransmission timer 340 may be maintained at the HARQ process level and autonomous retransmission of uplink data on a configured grant resource may be prohibited for the HARQ process while the configured grant retransmission timer 340 for the HARQ process is running.

The configured grant configuration information may additionally include other information associated with the configured grant. In some cases, the configured grant configuration information may be associated with a single configured grant. In other cases, the configured grant configuration information may be associated with multiple configured grants. The network entity 105-a may transmit the configured grant configuration to the UE 115-a via an RRC configuration message.

In some cases, it may be beneficial for a configuration associated with a configured grant to be adjusted based on network conditions, application requirements, UE behavior, or the like. For instance, it may be beneficial for a periodicity (e.g., a frequency) of the configured grant transmission occasions 310 or the configured grant retransmission occasions 320 to be adjusted based on the network conditions, application requirements, UE behavior, or the like. For example, when the UE 115-a experiences greater than a threshold amount of uplink latency, the UE 115-a may benefit from more frequent opportunities (e.g., a shorter periodicity) to transmit or retransmit uplink data. Alternatively, in cases when the UE 115-a experiences low latency, such as less than or equal to a threshold amount of uplink latency, the UE 115-a or the network may benefit from less frequent opportunities (e.g., a longer periodicity) to transmit or retransmit uplink data and resources that might have otherwise been used by the UE 115-a may be allocated to another UE, thereby increasing capacity at the network. In some cases, the network entity 105-a may be unaware of conditions at the UE 115-a and, therefore, might not be aware that adjustments to a configurated grant configuration may be beneficial. In such cases, the UE 115-a may assist the network entity 105-a by providing recommendation information to the network entity 105-a

For instance, the UE 115-a may be configured with a capability to signal, to the network entity 105-a, recommendation information associated with one or more configured grants or configured grant configurations, and the network entity 105-a may be configured with a capability to adjust configured grant configuration information based on a recommendation from the UE 115-a. In some cases, the UE 115-a may signal its capability to the network entity 105-a or the network entity 105-a may signal its capability to the UE 115-a or both.

The recommendation information may include recommendations for adjusting information (e.g., one or more parameters) associated with one or more configured grant configurations. For example, in some cases, the recommendation information may include recommended configured grant timer values, recommended configured grant retransmission timer values, or both. In some cases, the recommended configured grant timer values and recommended configured grant retransmission timer values may be bounded by minimum and maximum configured grant timer values or minimum and maximum configured grant retransmission timer values indicated in the configured grant configuration information from the network entity 105-a. In some cases, the recommendation information may include an indication of which configured grant configurations are to be associated with the recommended configured grant timer values, recommended configured grant retransmission timer values, or both. In some cases, the recommendation information may include an indication of a quantity of HARQ process for which the recommended configured grant timer values, recommended configured grant retransmission timer values, or both are to be maintained. In some cases, the recommendation information may include an indication of whether to disable a configured grant retransmission timer for a particular configured grant configuration. In some cases, the recommendation information may include an indication of whether to enable or disable the configured grant retransmission timer together with an HARQ retransmission timer. In some cases, the recommendation information may include other information associated with the configured grant configuration.

The UE 115-a may utilize an AI or machine learning model to determine or generate the recommendation information. For instance, the UE 115-a may utilize an AI or machine learning model to determine the recommendation information based on one or more KPIs (e.g., UPT, statistical experienced latencies, PER, etc.) associated with or measured at the UE 115-a, on configured grant configuration information, or a combination thereof. In some cases, if one or more of the KPIs fails to satisfy (e.g., falls below) a corresponding performance threshold, the recommendation information (e.g., a recommended configured grant timer value, recommended configured grant retransmission timer value, or both) may be for a default configured grant configuration parameter value (e.g., a default configured grant timer value or a default configured grant retransmission timer value).

Once generated, the UE 115-a may transmit the recommendation information to the network entity 105-a. In some cases, the UE 115-a may transmit (or generate) the recommendation information when a change (e.g., a change that satisfies a threshold value) is detected to one or more of the KPI measurements or when one or more of the KPI measurements fails to satisfy a performance threshold. In some cases, the UE 115-a may transmit, to the network entity 105-a) an indication of the KPI measurements with the recommendation information (or in a separate message). In other cases, the UE 115-a may transmit (or generate) the recommendation information based on receiving a request from the network entity 105-a for recommendation information or based on receiving an indication from the network entity 105-a of its capability to adjust configured grant confirmation information based on a recommendation from the UE 115-a.

In some cases, the UE 115-a may transmit the recommendation information periodically. Additionally, or alternatively, the UE 115-a may transmit the recommendation information after expiration of a prohibit timer. That is, the UE 115-a may be configured with a prohibit timer that controls how frequently the UE 115-a may be permitted to signal recommendation information. For instance, the configured grant configuration information may include a prohibit timer value that indicates a duration (e.g., a time delay) that the UE 115-a is to wait before signaling a subsequent request for adjustment to the configured grant configuration information.

The UE 115-a may transmit the recommendation information via control signaling. For instance, the UE 115-a may transmit the recommendation information via uplink assistance information, uplink control information, a MAC-control element (MAC-CE), or other control signaling.

As an example, the UE 115-a may transmit, via control signaling, a message that includes recommendation information, such as shown below:

```
cgretransmissions-native := SEQUENCE {
  Min− CG-Timer ENUMERATED { }
  Max CG-Timer ENUMERATED { }
  Min CG-ReTx Timer ENUMERATED { }
  Max CG-ReTx TimerENUMERATED { }
  CGs Applicable {CG indices}
}
```

Alternatively, the UE 115-a may transmit the recommendation information via a MAC-CE, such as shown below in Table 1.

TABLE 1

| CG₇ | CG₆ | CG₅ | CG₄ | CG₃ | CG₂ | CG₁ | CG₀ |
|---|---|---|---|---|---|---|---|
| 0 | 0 | 1 | 0 | 1 | 1 | 1 | 0 |

Where CGᵢ represents an index or ID for each of multiple configured grant configurations and where each corresponding field indicates whether the recommended values indicated in the recommendation information are applicable to that configured grant configuration. For instance, when the CGᵢ field is set to 1, the recommendation information may be enabled for (e.g., applied to) that configured grant configuration and when set to 0, the recommendation information may be disabled for (e.g., not applied to) that configured grant configuration.

Upon receiving the recommendation information, the network entity 105-a may determine whether to adjust configured grant configuration information in accordance with the recommendation information. In some cases, the network entity 105-a may determine not to adjust the configured grant configuration information based on the recommendation information or may determine to adjust the configured grant configuration information differently than recommended by the recommendation information. For instance, if the recommendation information includes indications of measurements of one or more KPIs (or if received via a separate message from the UE 115-a), the network entity 105-a may adjust configured grant configuration information (e.g., one or more parameters) to one or more default values (e.g., a default configured grant timer value or a default configured grant retransmission timer value) based on one or more of the KPI measurements failing to satisfy a performance threshold.

If the network entity 105-a determines to adjust configured grant configuration information (e.g., a configured grant timer, a configured grant retransmission timer, or both associated with one or more configured grant configurations), the network entity 105-a may update or adjust the configured grant configuration information to include the recommendation information (e.g., an adjusted configured grant timer value, an adjusted configured grant retransmission timer value, or both). In some cases, to avoid misalignment between the network entity 105-a and the UE 115-a, the network entity 105-a may confirm that the recommendation information was received successfully and that the recommended information was applied to one or more of the configured grant configurations. For instance, the network entity 105-a may transmit an acknowledgement message to the UE 115-a indicating successful receipt of the recommendation information. After adjusting the configured grant configuration information, the network entity 105-a may transmit the adjusted configured grant configuration information (e.g., the adjusted configured grant timer value, the adjusted configured grant retransmission timer value, or both) to the UE 115-a. The UE 115-a may, thereafter, use the adjusted configured grant configuration information (e.g., the adjusted configured grant timer value, the adjusted configured grant retransmission timer value, or both) when transmitting or retransmitting subsequent uplink data to the network entity 105-a.

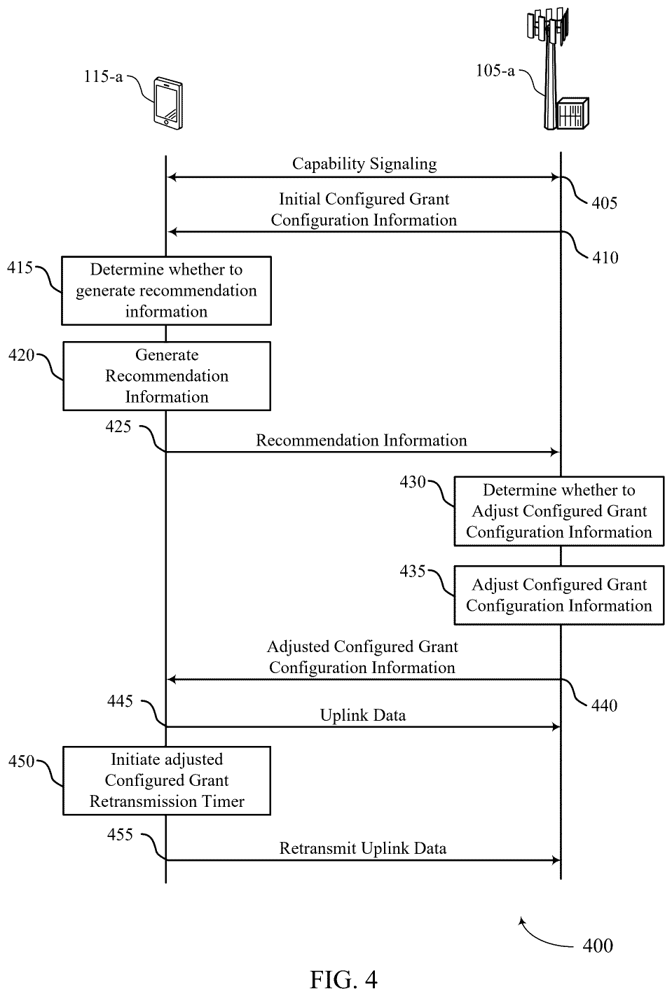

FIG. 4 shows an example of a process flow 400 that supports AI native configured grant timers in accordance with one or more aspects of the present disclosure. In some aspects, the process flow 400 may implement or be implemented by aspects of the wireless communications systems 100 and 200, and configured grant transmission scheme 300, as described with reference to FIGS. 1, 2, and 3, respectively. The process flow 400 may illustrate the flow of signals between the UE 115-a and the network entity 105-a, such as described with reference to FIGS. 1, 2, and 3. In the following description of the process flow 400, the communications between the various devices may be transmitted in a different order than the example order shown, or the operations performed by the various devices may be performed in different orders or at different times. Some operations may also be omitted from the process flow 400, and other operations may be added. In some examples, the operations illustrated in process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 405, the UE 115-a may transmit, and the network entity 105-a may receive, a message indicating a capability of the UE 115-a to provide, to the network entity 105-a, recommendation information associated with one or more configured grants or configured grant configurations. Additionally, or alternatively, the network entity 105-a may transmit, and the UE 115-a may receive, a message indicating a capability of the network entity 105-a to adjust configured grant configuration information based on a recommendation from the UE 115-a.

At 410, the network entity 105-a may transmit, and the UE 115-a may receive, initial configured grant configuration information. The initial configured grant configuration information may be associated with one or more configured grants for periodic uplink communications from the UE 115-a to the network entity 105-a. The UE 115-a may receive the initial configured grant configuration via RRC configuration information.

At 415, the UE 115-a may determine whether to generate recommendation information associated with one or more configured grants or configured grant configurations. In some cases, the UE 115-a may decide to generate the recommendation information based on detecting a change (that satisfies a threshold) to one or more KPI measurements associated with the UE 115-a or based on determining that one or more of the KPI measurements fails to satisfy a performance threshold. In some cases, the UE 115-a may include an indication of KPI measurements in the recommendation information. In some cases, the UE 115-a may decide to generate the recommendation information based on receiving, from the network entity 105-a, the message indicating the capability of the network entity 105-a to adjust configured grant configuration information based on a recommendation from the UE 115-a or based on receiving a message from the network entity 105-a requesting that the UE 115-a send the recommendation information. The UE 115-a may transmit the recommendation information to the network entity 105-a via control signaling.

At 420, the UE 115-a may utilize an AI or machine learning model (e.g., native to or implemented at the UE 115-a) to generate the recommendation information. For instance, the AI or machine learning model may be trained to output one or more recommended adjustments to one or more parameter values associated with the configured grant configuration information based on receiving as input one or more KPI measurements, information associated with one or more configured grant configurations, or a combination thereof. For example, one or more KPI measurements and configured grant configuration information may be input to the model and the model may output recommendation information indicating a recommended adjustment to a value of a configured grant retransmission timer associated with the configuration information. In some cases, different recommendations may be output for different configured grant configurations and the recommendation information may include indications of which recommendation information is associated with which configured grant configuration information. The recommendation information generated by the model may additionally, or alternatively, include an indication of a quantity of HARQ process for which the recommendation information is to be maintained, an indication of whether to disable a configured grant retransmission timer for a particular configured grant configuration, or an indication of whether to enable or disable a configured grant retransmission timer together with an HARQ retransmission timer. In some cases, the recommendation information generated by the model may include other information associated with the configured grant configuration.

At 425, the UE 115-a may transmit, and the network entity 105-a may receive, the recommendation information associated with one or more configured grants or configured grant configurations. For example, the recommendation information may include a recommendation to adjust a value of a retransmission timer associated with a first configured grant or a first configured grant configuration.

At 430, the network entity 105-a may receive the recommendation information and determine whether to adjust configured grant configuration information associated with one or more configured grant configurations.

At 435, the network entity 105-a may determine to adjust configured grant configuration information associated with one or more configured grant configurations. Accordingly, the network entity 105-a may adjust the configured grant configuration information based on the recommendation information. For example, the network entity 105-a may adjust a value of a retransmission timer associated with a first configured grant or a first configured grant configuration in accordance with the recommendation information provided by the UE 115-a.

At 440, the network entity 105-a may transmit, and the UE 115-a may receive, adjusted configured grant configuration information. For example, the adjusted configured grant configuration information may include the adjusted value for the retransmission timer associated with the first configured grant timer or the first configured grant configuration in accordance with the recommendation information provided by the UE 115-a. The network entity 105-a may transmit the adjusted configured grant configuration information via control signaling, such as uplink assistance information, uplink control information, or a MAC-CE.

At 445, based on detecting new uplink data to be transmitted to the network entity 105-a during a configured grant period, the UE 115-a may transmit the uplink data on a first configured grant transmission occasion resource, such as a first configured grant transmission occasion 310-a, as shown in FIG. 3.

At 450, based on determining that an ACK is not received in a predetermined period of time or a NACK is received, the UE 115-a may initiate (e.g., start) the configured grant retransmission timer, such as the configured grant retransmission timer 340, shown in FIG. 3. A duration of the configured grant retransmission timer 340 may be based on the adjusted configured grant retransmission timer value indicated in the adjusted configured grant configuration information.

At 455, based on expiration of the adjusted configured grant retransmission timer 340, the UE 115-a may retransmit the uplink data in a next configured grant retransmission occasion, such as a first configured grant retransmission occasion 320-a1. A timing of the next configured grant retransmission occasion 320-a1 may align with an expiration of the adjusted configured grant retransmission timer 340.

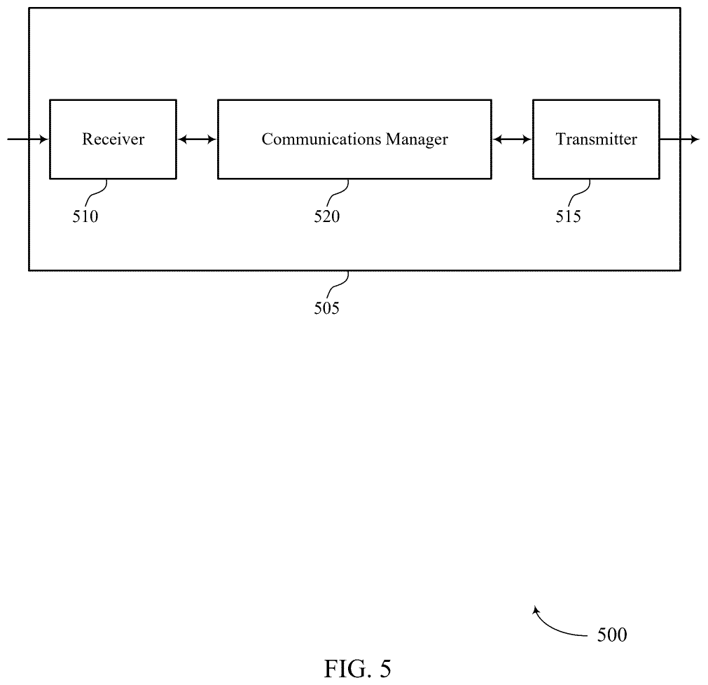

FIG. 5 shows a block diagram 500 of a device 505 that supports AI native configured grant timers in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to AI native configured grant timers). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to AI native configured grant timers). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of AI native configured grant timers as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting a message that indicates recommendation information for one or more configured grants for the UE. The communications manager 520 is capable of, configured to, or operable to support a means for receiving configuration information for the one or more configured grants, where the one or more configured grants indicate periodic uplink resources for one or more respective configured grant periods, where the periodic uplink resources include transmission occasions allocated for uplink transmissions, and where the configuration information indicates at least one configured grant timer value that is associated with at least one configured grant period of the one or more respective configured grant periods and that is based on the recommendation information. The communications manager 520 is capable of, configured to, or operable to support a means for initiating a first configured grant timer based on transmission of an uplink message during a first transmission occasion of a set of transmission occasions within a first configured grant period of the at least one configured grant period, where a duration of the first configured grant timer is based on a first configured grant timer value associated with the at least one configured grant timer value. The communications manager 520 is capable of, configured to, or operable to support a means for transmitting, based on expiration of the first configured grant timer, a retransmission of the uplink message in a subsequent transmission occasion of the set of transmission occasions.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

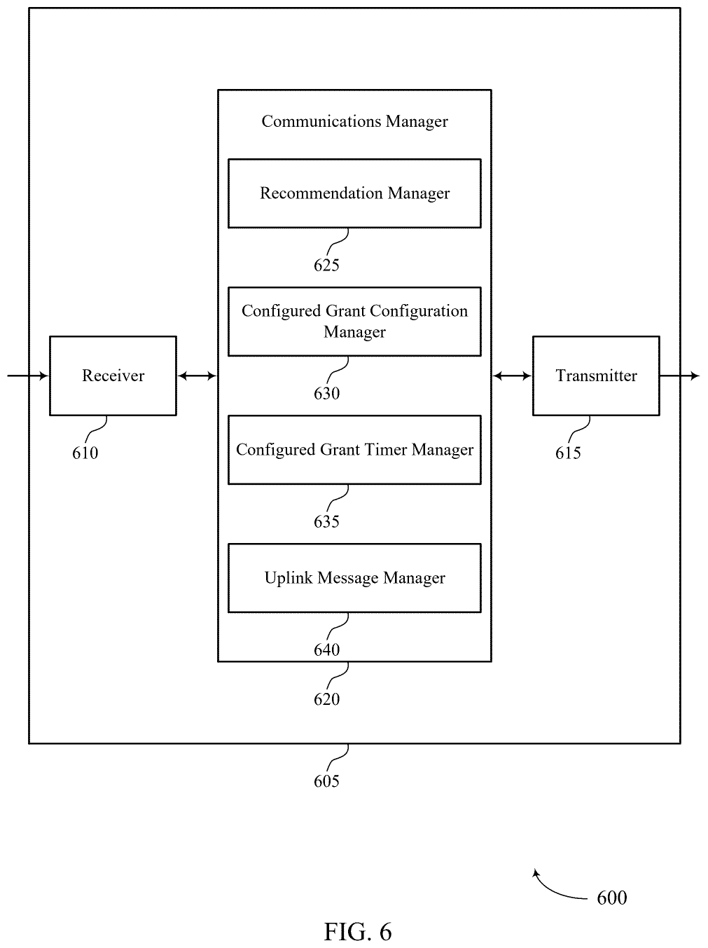

FIG. 6 shows a block diagram 600 of a device 605 that supports AI native configured grant timers in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to AI native configured grant timers). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to AI native configured grant timers). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of AI native configured grant timers as described herein. For example, the communications manager 620 may include a recommendation manager 625, a configured grant configuration manager 630, a configured grant timer manager 635, an uplink message manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The recommendation manager 625 is capable of, configured to, or operable to support a means for transmitting a message that indicates recommendation information for one or more configured grants for the UE. The configured grant configuration manager 630 is capable of, configured to, or operable to support a means for receiving configuration information for the one or more configured grants, where the one or more configured grants indicate periodic uplink resources for one or more respective configured grant periods, where the periodic uplink resources include transmission occasions allocated for uplink transmissions, and where the configuration information indicates at least one configured grant timer value that is associated with at least one configured grant period of the one or more respective configured grant periods and that is based on the recommendation information. The configured grant timer manager 635 is capable of, configured to, or operable to support a means for initiating a first configured grant timer based on transmission of an uplink message during a first transmission occasion of a set of transmission occasions within a first configured grant period of the at least one configured grant period, where a duration of the first configured grant timer is based on a first configured grant timer value associated with the at least one configured grant timer value. The uplink message manager 640 is capable of, configured to, or operable to support a means for transmitting, based on expiration of the first configured grant timer, a retransmission of the uplink message in a subsequent transmission occasion of the set of transmission occasions.

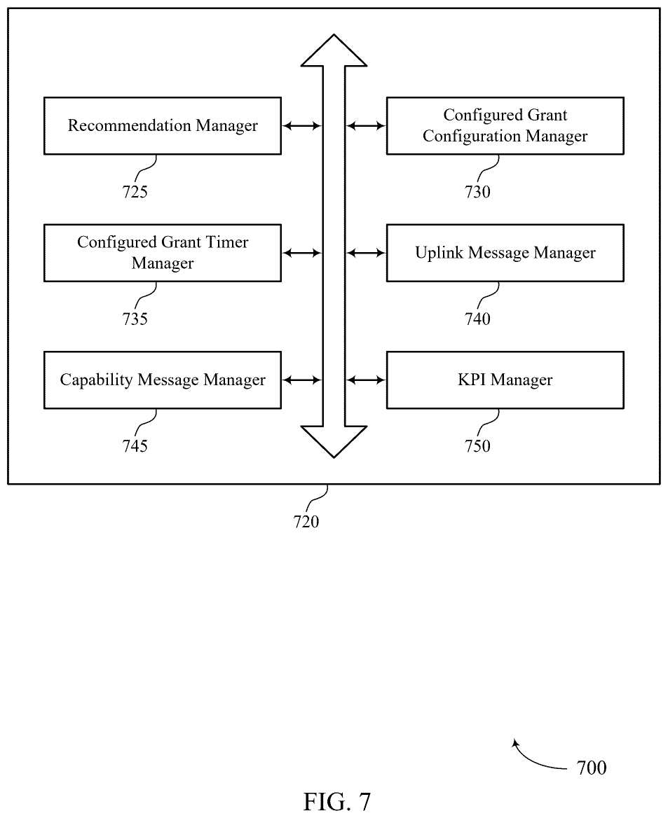

FIG. 7 shows a block diagram 700 of a communications manager 720 that supports AI native configured grant timers in accordance with one or more aspects of the present disclosure. The communications manager 720 may be an example of aspects of a communications manager 520, a communications manager 620, or both, as described herein. The communications manager 720, or various components thereof, may be an example of means for performing various aspects of AI native configured grant timers as described herein. For example, the communications manager 720 may include a recommendation manager 725, a configured grant configuration manager 730, a configured grant timer manager 735, an uplink message manager 740, a capability message manager 745, a KPI manager 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The recommendation manager 725 is capable of, configured to, or operable to support a means for transmitting a message that indicates recommendation information for one or more configured grants for the UE. The configured grant configuration manager 730 is capable of, configured to, or operable to support a means for receiving configuration information for the one or more configured grants, where the one or more configured grants indicate periodic uplink resources for one or more respective configured grant periods, where the periodic uplink resources include transmission occasions allocated for uplink transmissions, and where the configuration information indicates at least one configured grant timer value that is associated with at least one configured grant period of the one or more respective configured grant periods and that is based on the recommendation information. The configured grant timer manager 735 is capable of, configured to, or operable to support a means for initiating a first configured grant timer based on transmission of an uplink message during a first transmission occasion of a set of transmission occasions within a first configured grant period of the at least one configured grant period, where a duration of the first configured grant timer is based on a first configured grant timer value associated with the at least one configured grant timer value. The uplink message manager 740 is capable of, configured to, or operable to support a means for transmitting, based on expiration of the first configured grant timer, a retransmission of the uplink message in a subsequent transmission occasion of the set of transmission occasions.

In some examples, the capability message manager 745 is capable of, configured to, or operable to support a means for transmitting a capability message indicating a capability of the UE to recommend, in the recommendation information, an adjustment to a configured grant timer parameter.

In some examples, to support transmitting the message, the recommendation manager 725 is capable of, configured to, or operable to support a means for transmitting the message via uplink assistance information, uplink control information, or a MAC-CE.

In some examples, the capability message manager 745 is capable of, configured to, or operable to support a means for receiving a second message requesting a recommendation for adjustment to a configured grant timer parameter or indicating a capability of a network entity to adjust a configured grant timer parameter based on a UE recommendation, where transmitting the message is based on reception of the second message. In some examples, the recommendation manager 725 is capable of, configured to, or operable to support a means for transmitting the message based on receiving the second message.

In some examples, the recommendation manager 725 is capable of, configured to, or operable to support a means for receiving an acknowledgement message of successful receipt of the message indicating the recommendation information.

In some examples, the at least one configured grant timer value includes a maximum configured grant timer value and a minimum timer value, and the configured grant timer manager 735 is capable of, configured to, or operable to support a means for selecting the first configured grant timer value, where the first configured grant timer value is less than or equal to the maximum configured grant timer value and greater than or equal to the minimum timer value. In some examples, the at least one configured grant timer value includes a maximum configured grant timer value and a minimum timer value, and the recommendation manager 725 is capable of, configured to, or operable to support a means for transmitting a second message indicating second recommendation information, where the second recommendation information includes the first configured grant timer value.

In some examples, the KPI manager 750 is capable of, configured to, or operable to support a means for transmitting a second message including one or more indications of one or more performance indicators associated with the UE.

In some examples, the recommendation manager 725 is capable of, configured to, or operable to support a means for transmitting, based on one or more performance indicators failing to satisfy a performance threshold, a second message indicating second recommendation information, where the second recommendation information includes one or more default configured grant timer parameter values.

In some examples, to support transmitting the message, the recommendation manager 725 is capable of, configured to, or operable to support a means for transmitting the message based on detecting that a performance indicator fails to satisfy a performance threshold.

In some examples, the recommendation manager 725 is capable of, configured to, or operable to support a means for generating, using a machine learning model, and based on one or more performance indicators associated with the UE, the recommendation information.

In some examples, the configuration information indicates a prohibit timer value indicating a time duration for delaying a subsequent request for adjustment to a configured grant timer parameter.

In some examples, the recommendation information includes one or more configured grant timer parameter values. In some examples, the message includes indications of which of the one or more configured grant timer parameter values are associated with which of the one or more configured grants.

In some examples, the recommendation information includes an indication that a configured grant timer for an associated configured grant is to be disabled, an indication of whether to enable or disable both a configured grant timer for an associated configured grant and an HARQ retransmission timer, or a combination thereof.

In some examples, the message includes an indication of a quantity of HARQ processes for which at least one configured grant timer parameter value indicated by the recommendation information is to be maintained.

In some examples, the subsequent transmission occasion aligns with the expiration of the first configured grant timer.

In some examples, the first configured grant timer includes a configured grant timer or a configured grant retransmission timer.

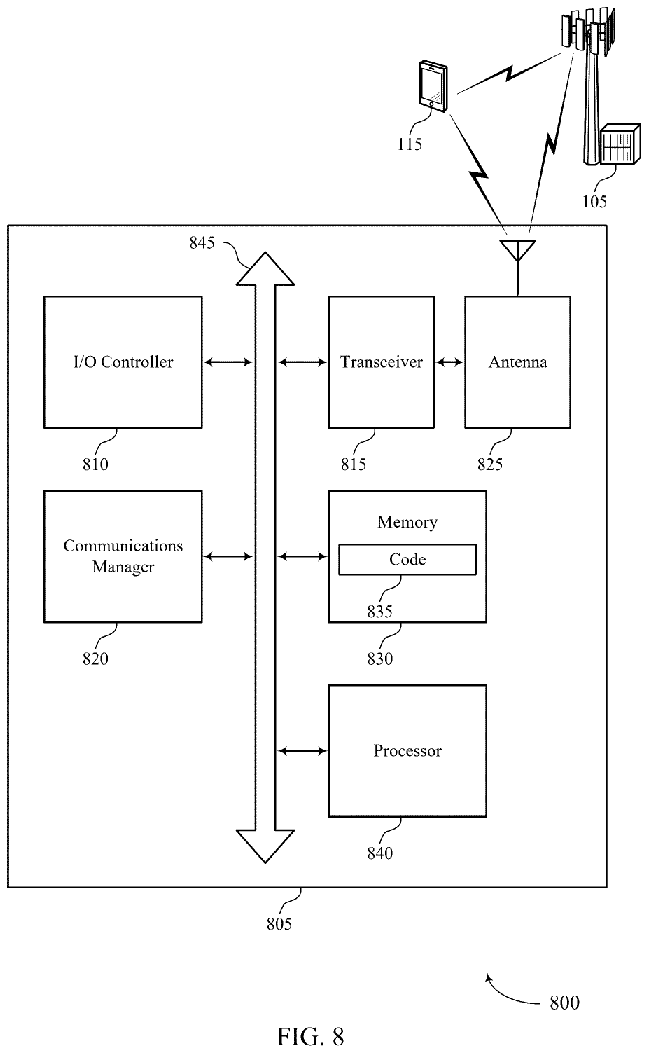

FIG. 8 shows a diagram of a system 800 including a device 805 that supports AI native configured grant timers in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting AI native configured grant timers). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting a message that indicates recommendation information for one or more configured grants for the UE. The communications manager 820 is capable of, configured to, or operable to support a means for receiving configuration information for the one or more configured grants, where the one or more configured grants indicate periodic uplink resources for one or more respective configured grant periods, where the periodic uplink resources include transmission occasions allocated for uplink transmissions, and where the configuration information indicates at least one configured grant timer value that is associated with at least one configured grant period of the one or more respective configured grant periods and that is based on the recommendation information. The communications manager 820 is capable of, configured to, or operable to support a means for initiating a first configured grant timer based on transmission of an uplink message during a first transmission occasion of a set of transmission occasions within a first configured grant period of the at least one configured grant period, where a duration of the first configured grant timer is based on a first configured grant timer value associated with the at least one configured grant timer value. The communications manager 820 is capable of, configured to, or operable to support a means for transmitting, based on expiration of the first configured grant timer, a retransmission of the uplink message in a subsequent transmission occasion of the set of transmission occasions.

By including or configuring the communications manager 820 in accordance with examples as described herein, the device 805 may support techniques for improved communication reliability, reduced latency, and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of AI native configured grant timers as described herein, or the at least one processor 840 and the at least one memory 830 may be otherwise configured to, individually or collectively, perform or support such operations.

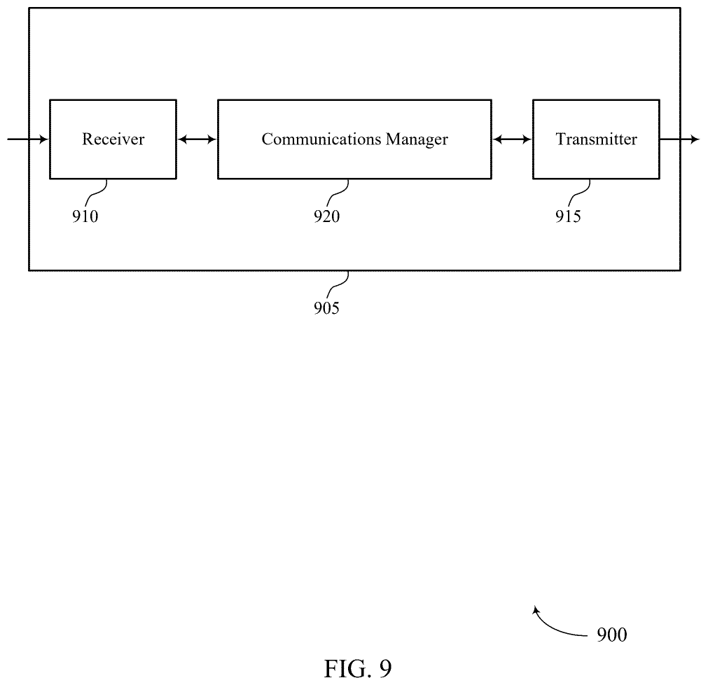

FIG. 9 shows a block diagram 900 of a device 905 that supports AI native configured grant timers in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of AI native configured grant timers as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving a message indicating recommendation information for one or more configured grants for a UE. The communications manager 920 is capable of, configured to, or operable to support a means for generating configuration information for the one or more configured grants, where the one or more configured grants indicate periodic uplink resources for one or more respective configured grant periods, and where the periodic uplink resources include transmission occasions allocated for uplink transmissions. The communications manager 920 is capable of, configured to, or operable to support a means for adjusting, based at least in part on the recommendation information, at least one configured grant timer value of at least one respective configured grant timer, where the at least one respective configured grant timer is associated with at least one configured grant of the one or more configured grants. The communications manager 920 is capable of, configured to, or operable to support a means for transmitting the configuration information for the one or more configured grants.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

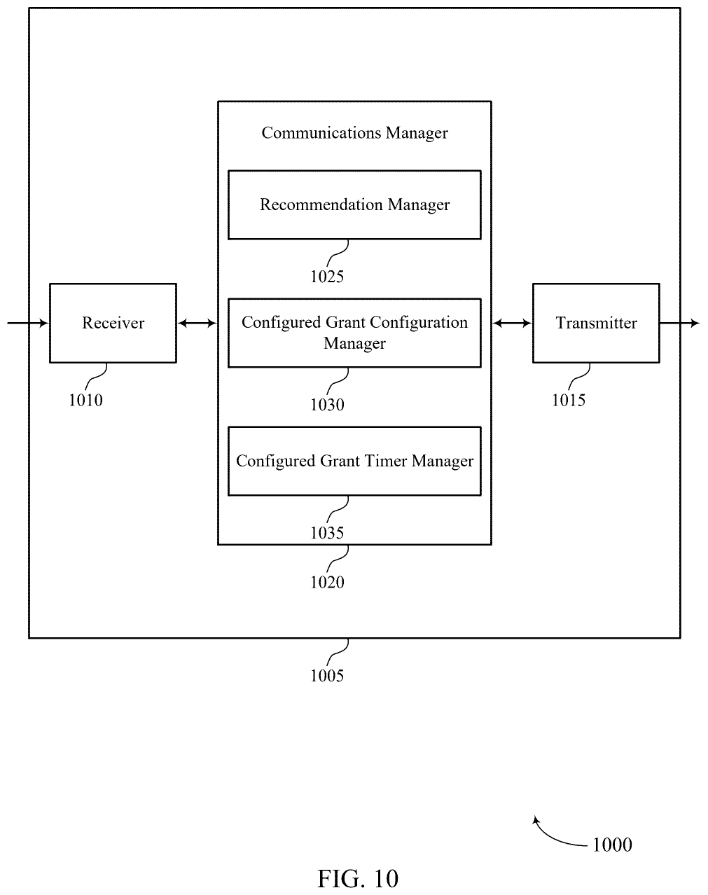

FIG. 10 shows a block diagram 1000 of a device 1005 that supports AI native configured grant timers in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of AI native configured grant timers as described herein. For example, the communications manager 1020 may include a recommendation manager 1025, a configured grant configuration manager 1030, a configured grant timer manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The recommendation manager 1025 is capable of, configured to, or operable to support a means for receiving a message indicating recommendation information for one or more configured grants for a UE. The configured grant configuration manager 1030 is capable of, configured to, or operable to support a means for generating configuration information for the one or more configured grants, where the one or more configured grants indicate periodic uplink resources for one or more respective configured grant periods, and where the periodic uplink resources include transmission occasions allocated for uplink transmissions. The configured grant timer manager 1035 is capable of, configured to, or operable to support a means for adjusting, based on the recommendation information, at least one configured grant timer value of at least one respective configured grant timer, where the at least one respective configured grant timer is associated with at least one configured grant of the one or more configured grants. The configured grant timer manager 1035 is capable of, configured to, or operable to support a means for transmitting the configuration information for the one or more configured grants.

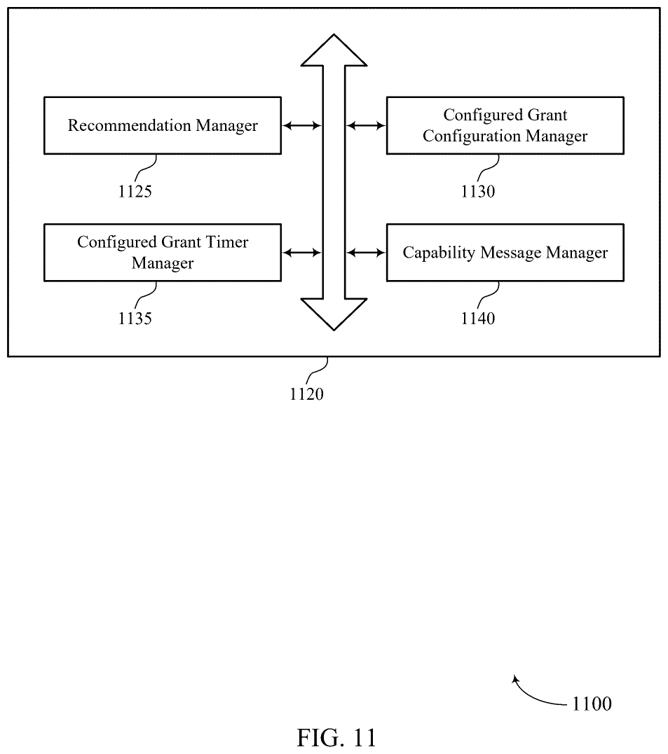

FIG. 11 shows a block diagram 1100 of a communications manager 1120 that supports AI native configured grant timers in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of AI native configured grant timers as described herein. For example, the communications manager 1120 may include a recommendation manager 1125, a configured grant configuration manager 1130, a configured grant timer manager 1135, a capability message manager 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The recommendation manager 1125 is capable of, configured to, or operable to support a means for receiving a message indicating recommendation information for one or more configured grants for a UE. The configured grant configuration manager 1130 is capable of, configured to, or operable to support a means for generating configuration information for the one or more configured grants, where the one or more configured grants indicate periodic uplink resources for one or more respective configured grant periods, and where the periodic uplink resources include transmission occasions allocated for uplink transmissions. The configured grant timer manager 1135 is capable of, configured to, or operable to support a means for adjusting, based on the recommendation information, at least one configured grant timer value of at least one respective configured grant timer, where the at least one respective configured grant timer is associated with at least one configured grant of the one or more configured grants. In some examples, the configured grant timer manager 1135 is capable of, configured to, or operable to support a means for transmitting the configuration information for the one or more configured grants.

In some examples, the capability message manager 1140 is capable of, configured to, or operable to support a means for transmitting a capability message indicating a capability of the network entity to adjust a configured grant timer parameter based on a UE recommendation.

In some examples, to support receiving the message, the recommendation manager 1125 is capable of, configured to, or operable to support a means for receiving the message via uplink assistance information, uplink control information, or a MAC-CE.

In some examples, to support receiving the message, the capability message manager 1140 is capable of, configured to, or operable to support a means for transmitting a second message requesting a recommendation for adjustment to a configured grant timer parameter or indicating a capability to adjust a configured grant timer parameter based on a UE recommendation, where receiving the message is based on transmission of the second message. In some examples, to support receiving the message, the recommendation manager 1125 is capable of, configured to, or operable to support a means for receiving the message based on transmitting the second message.

In some examples, the recommendation manager 1125 is capable of, configured to, or operable to support a means for transmitting, based on receiving the message indicating the recommendation information, an acknowledgement message of successful receipt of the recommendation information.

In some examples, the at least one configured grant timer value includes a maximum configured grant timer value and a minimum timer value, and the recommendation manager 1125 is capable of, configured to, or operable to support a means for receiving a second message indicating second recommendation information, where the second recommendation information includes a configured grant timer parameter value that is less than or equal to the maximum configured grant timer value and greater than or equal to the minimum timer value.

In some examples, the configured grant timer manager 1135 is capable of, configured to, or operable to support a means for receiving a second message including one or more indications of one or more performance indicators associated with the UE. In some examples, the configured grant timer manager 1135 is capable of, configured to, or operable to support a means for adjusting, based on at least one of the one or more performance indicators failing to satisfy a performance threshold, a configured grant timer value of at least one configured grant timer associated with at least one of the one or more configured grants to a default configured grant timer value.

In some examples, the configuration information indicates a prohibit timer value indicating a time duration for the UE to delay transmission of a subsequent request for adjustment to a configured grant timer parameter.

In some examples, the recommendation information includes one or more configured grant timer parameter values. In some examples, the message includes indications of which of the one or more configured grant timer parameter values are associated with which of the one or more configured grants.

In some examples, the recommendation information includes an indication that a configured grant timer for an associated configured grant is to be disabled, an indication of whether to enable or disable both a configured grant timer for an associated configured grant and an HARQ retransmission timer, or a combination thereof.

In some examples, the message includes an indication of a quantity of HARQ processes for which at least one configured grant timer parameter value indicated by the recommendation information is to be maintained.

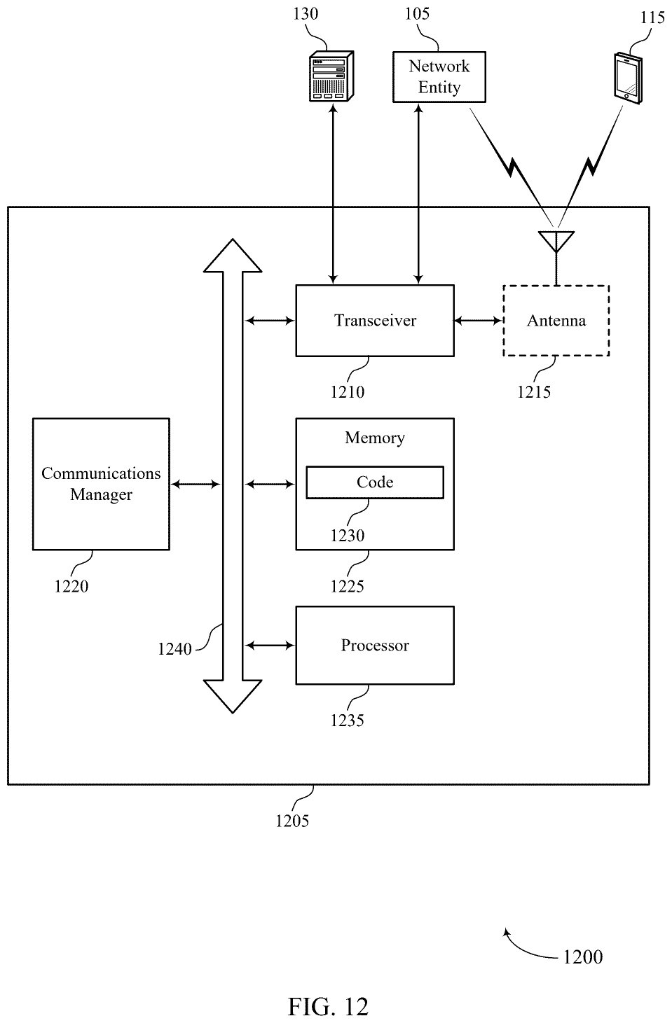

FIG. 12 shows a diagram of a system 1200 including a device 1205 that supports AI native configured grant timers in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting AI native configured grant timers). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for receiving a message indicating recommendation information for one or more configured grants for a UE. The communications manager 1220 is capable of, configured to, or operable to support a means for generating configuration information for the one or more configured grants, where the one or more configured grants indicate periodic uplink resources for one or more respective configured grant periods, and where the periodic uplink resources include transmission occasions allocated for uplink transmissions. The communications manager 1220 is capable of, configured to, or operable to support a means for adjusting, based at least in part on the recommendation information, at least one configured grant timer value of at least one respective configured grant timer, where the at least one respective configured grant timer is associated with at least one configured grant of the one or more configured grants. The communications manager 1220 is capable of, configured to, or operable to support a means for transmitting the configuration information for the one or more configured grants.

By including or configuring the communications manager 1220 in accordance with examples as described herein, the device 1205 may support techniques for improved communication reliability, reduced latency, and more efficient utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of AI native configured grant timers as described herein, or the at least one processor 1235 and the at least one memory 1225 may be otherwise configured to, individually or collectively, perform or support such operations.

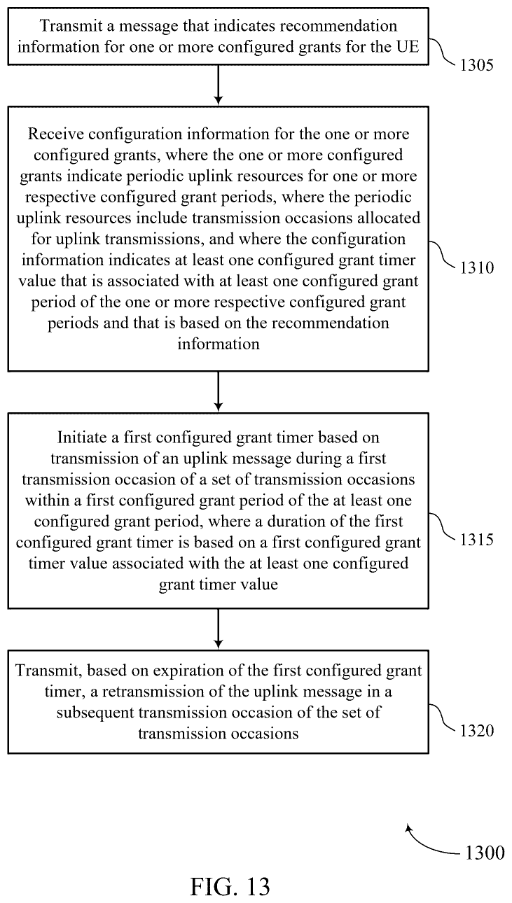

FIG. 13 shows a flowchart illustrating a method 1300 that supports AI native configured grant timers in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting a message that indicates recommendation information for one or more configured grants for the UE. The operations of 1305 may be performed in accordance with examples as disclosed herein. In some examples, aspects of the operations of 1305 may be performed by a recommendation manager 725 as described with reference to FIG. 7.

At 1310, the method may include receiving configuration information for the one or more configured grants, where the one or more configured grants indicate periodic uplink resources for one or more respective configured grant periods, where the periodic uplink resources include transmission occasions allocated for uplink transmissions, and where the configuration information indicates at least one configured grant timer value that is associated with at least one configured grant period of the one or more respective configured grant periods and that is based on the recommendation information. The operations of 1310 may be performed in accordance with examples as disclosed herein. In some examples, aspects of the operations of 1310 may be performed by a configured grant configuration manager 730 as described with reference to FIG. 7.

At 1315, the method may include initiating a first configured grant timer based on transmission of an uplink message during a first transmission occasion of a set of transmission occasions within a first configured grant period of the at least one configured grant period, where a duration of the first configured grant timer is based on a first configured grant timer value associated with the at least one configured grant timer value. The operations of 1315 may be performed in accordance with examples as disclosed herein. In some examples, aspects of the operations of 1315 may be performed by a configured grant timer manager 735 as described with reference to FIG. 7.

At 1320, the method may include transmitting, based on expiration of the first configured grant timer, a retransmission of the uplink message in a subsequent transmission occasion of the set of transmission occasions. The operations of 1320 may be performed in accordance with examples as disclosed herein. In some examples, aspects of the operations of 1320 may be performed by an uplink message manager 740 as described with reference to FIG. 7.

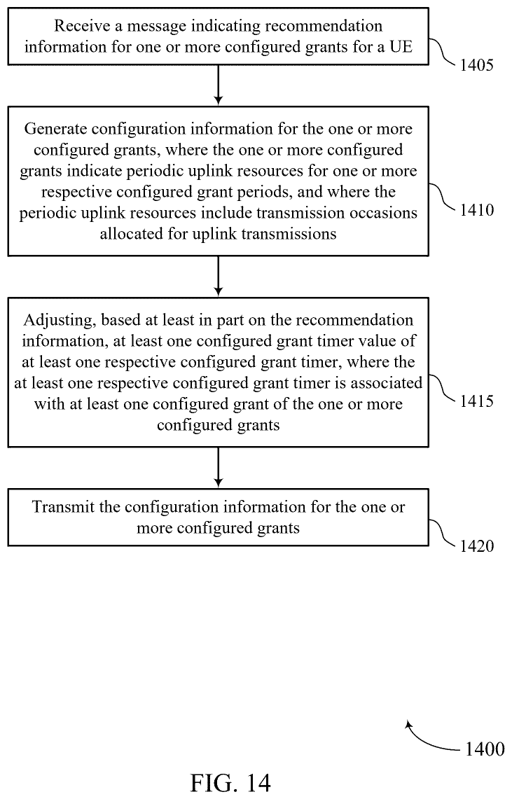

FIG. 14 shows a flowchart illustrating a method 1400 that supports AI native configured grant timers in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include receiving a message indicating recommendation information for one or more configured grants for a UE. The operations of 1405 may be performed in accordance with examples as disclosed herein. In some examples, aspects of the operations of 1405 may be performed by a recommendation manager 1125 as described with reference to FIG. 11.

At 1410, the method may include generating configuration information for the one or more configured grants, where the one or more configured grants indicate periodic uplink resources for one or more respective configured grant periods, and where the periodic uplink resources include transmission occasions allocated for uplink transmissions. The operations of 1410 may be performed in accordance with examples as disclosed herein. In some examples, aspects of the operations of 1410 may be performed by a configured grant configuration manager 1130 as described with reference to FIG. 11.

At 1415, the method may include adjusting, based on the recommendation information, at least one configured grant timer value of at least one respective configured grant timer, where the at least one respective configured grant timer is associated with at least one configured grant of the one or more configured grants. The operations of 1415 may be performed in accordance with examples as disclosed herein. In some examples, aspects of the operations of 1415 may be performed by a configured grant timer manager 1135 as described with reference to FIG. 11.

At 1420, the method may include transmitting the configuration information for the one or more configured grants. The operations of 1420 may be performed in accordance with examples as disclosed herein. In some examples, aspects of the operations of 1420 may be performed by a configured grant timer manager 1135 as described with reference to FIG. 11.

The following provides an overview of aspects of the present disclosure:

Aspect 1: A method for wireless communications by a UE, comprising: transmitting a message that indicates recommendation information for one or more configured grants for the UE; receiving configuration information for the one or more configured grants, wherein the one or more configured grants indicate periodic uplink resources for one or more respective configured grant periods, wherein the periodic uplink resources include transmission occasions allocated for uplink transmissions, and wherein the configuration information indicates at least one configured grant timer value that is associated with at least one configured grant period of the one or more respective configured grant periods and that is based at least in part on the recommendation information; initiating a first configured grant timer based at least in part on transmission of an uplink message during a first transmission occasion of a set of transmission occasions within a first configured grant period of the at least one configured grant period, wherein a duration of the first configured grant timer is based at least in part on a first configured grant timer value associated with the at least one configured grant timer value; and transmitting, based at least in part on expiration of the first configured grant timer, a retransmission of the uplink message in a subsequent transmission occasion of the set of transmission occasions.

Aspect 2: The method of aspect 1, further comprising: transmitting a capability message indicating a capability of the UE to recommend, in the recommendation information, an adjustment to a configured grant timer parameter.

Aspect 3: The method of any of aspects 1 through 2, wherein transmitting the message comprises: transmitting the message via uplink assistance information, uplink control information, or a medium access control-control element (MAC-CE).

Aspect 4: The method of any of aspects 1 through 3, wherein receiving a second message that indicates a request for a recommendation for adjustment to a configured grant timer parameter or indicates a capability of a network entity to adjust a configured grant timer parameter based at least in part on a UE recommendation, wherein transmitting the message comprises: transmitting the message based at least in part on receiving the second message.

Aspect 5: The method of any of aspects 1 through 4, further comprising: receiving an acknowledgement message of successful receipt of the recommendation information.

Aspect 6: The method of any of aspects 1 through 5, wherein the at least one configured grant timer value comprises a maximum configured grant timer value and a minimum timer value, and wherein the method further comprises: selecting the first configured grant timer value, wherein the first configured grant timer value is less than or equal to the maximum configured grant timer value and greater than or equal to the minimum timer value; and transmitting a second message indicating second recommendation information, wherein the second recommendation information comprises the first configured grant timer value.

Aspect 7: The method of any of aspects 1 through 6, further comprising: transmitting a second message comprising one or more indications of one or more performance indicators associated with the UE.

Aspect 8: The method of any of aspects 1 through 7, further comprising: transmitting, based at least in part on one or more performance indicators failing to satisfy a performance threshold, a second message indicating second recommendation information, wherein the second recommendation information comprises one or more default configured grant timer parameter values.

Aspect 9: The method of any of aspects 1 through 8, wherein transmitting the message comprises: transmitting the message based at least in part on detecting that a performance indicator fails to satisfy a performance threshold.

Aspect 10: The method of any of aspects 1 through 9, further comprising: generating, using a machine learning model and based at least in part on one or more performance indicators associated with the UE, the recommendation information.

Aspect 11: The method of any of aspects 1 through 10, wherein the configuration information indicates a prohibit timer value indicating a time duration to delay a subsequent request for adjustment to a configured grant timer parameter.

Aspect 12: The method of any of aspects 1 through 11, wherein the recommendation information comprises one or more configured grant timer parameter values, and the message comprises indications of which of the one or more configured grant timer parameter values are associated with which of the one or more configured grants.

Aspect 13: The method of any of aspects 1 through 12, wherein the recommendation information comprises an indication that a configured grant timer for an associated configured grant is to be disabled, an indication of whether to enable or disable both a configured grant timer for an associated configured grant and an HARQ retransmission timer, or a combination thereof.

Aspect 14: The method of any of aspects 1 through 13, wherein the message comprises an indication of a quantity of HARQ processes for which at least one configured grant timer parameter value indicated by the recommendation information is to be maintained.

Aspect 15: The method of any of aspects 1 through 14, wherein the subsequent transmission occasion aligns with the expiration of the first configured grant timer.

Aspect 16: The method of any of aspects 1 through 15, wherein the first configured grant timer comprises a configured grant timer or a configured grant retransmission timer.

Aspect 17: A method for wireless communications by a network entity, comprising: receiving a message indicating recommendation information for one or more configured grants for a UE; generating configuration information for the one or more configured grants, wherein the one or more configured grants indicate periodic uplink resources for one or more respective configured grant periods, and wherein the periodic uplink resources include transmission occasions allocated for uplink transmissions; adjusting, based at least in part on the recommendation information, at least one configured grant timer value of at least one respective configured grant timer, wherein the at least one respective configured grant timer is associated with at least one configured grant of the one or more configured grants; and transmitting the configuration information for the one or more configured grants.

Aspect 18: The method of aspect 17, further comprising: transmitting a capability message indicating a capability of the network entity to adjust a configured grant timer parameter based at least in part on a UE recommendation.

Aspect 19: The method of any of aspects 17 through 18, wherein receiving the message comprises: receiving the message via uplink assistance information, uplink control information, or a medium access control-control element (MAC-CE).

Aspect 20: The method of any of aspects 17 through 19, wherein receiving the message comprises: transmitting a second message that indicates a request for a recommendation for adjustment to a configured grant timer parameter or indicating a capability to adjust a configured grant timer parameter based at least in part on a UE recommendation, wherein receiving the message comprises: receiving the message based at least in part on transmitting the second message.

Aspect 21: The method of any of aspects 17 through 20, further comprising: transmitting, based at least in part on receiving the message indicating the recommendation information, an acknowledgement message of successful receipt of the recommendation information.

Aspect 22: The method of any of aspects 17 through 21, wherein the at least one configured grant timer value comprises a maximum configured grant timer value and a minimum timer value, and wherein the method further comprises: receiving a second message indicating second recommendation information, wherein the second recommendation information comprises a configured grant timer parameter value that is less than or equal to the maximum configured grant timer value and greater than or equal to the minimum timer value.

Aspect 23: The method of any of aspects 17 through 22, further comprising: receiving a second message comprising one or more indications of one or more performance indicators associated with the UE; and adjusting, based at least in part on at least one of the one or more performance indicators failing to satisfy a performance threshold, a configured grant timer value of at least one configured grant timer associated with at least one of the one or more configured grants to a default configured grant timer value.

Aspect 24: The method of any of aspects 17 through 23, wherein the configuration information indicates a prohibit timer value indicating a time duration for the UE to delay transmission of a subsequent request for adjustment to a configured grant timer parameter.

Aspect 25: The method of any of aspects 17 through 24, wherein the recommendation information comprises one or more configured grant timer parameter values, and the message comprises indications of which of the one or more configured grant timer parameter values are associated with which of the one or more configured grants.

Aspect 26: The method of any of aspects 17 through 25, wherein the recommendation information comprises an indication that a configured grant timer for an associated configured grant is to be disabled, an indication of whether to enable or disable both a configured grant timer for an associated configured grant and an HARQ retransmission timer, or a combination thereof.

Aspect 27: The method of any of aspects 17 through 26, wherein the message comprises an indication of a quantity of HARQ processes for which at least one configured grant timer parameter value indicated by the recommendation information is to be maintained.

Aspect 28: A UE for wireless communications, comprising one or more memories storing processor-executable code, and one or more processors coupled with the one or more memories and individually or collectively operable to execute the code to cause the UE to perform a method of any of aspects 1 through 16.

Aspect 29: A UE for wireless communications, comprising at least one means for performing a method of any of aspects 1 through 16.

Aspect 30: A non-transitory computer-readable medium storing code for wireless communications, the code comprising instructions executable by one or more processors to perform a method of any of aspects 1 through 16.

Aspect 31: A network entity for wireless communications, comprising one or more memories storing processor-executable code, and one or more processors coupled with the one or more memories and individually or collectively operable to execute the code to cause the network entity to perform a method of any of aspects 17 through 27.

Aspect 32: A network entity for wireless communications, comprising at least one means for performing a method of any of aspects 17 through 27.

Aspect 33: A non-transitory computer-readable medium storing code for wireless communications, the code comprising instructions executable by one or more processors to perform a method of any of aspects 17 through 27.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, a NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a message that indicates recommendation information for one or more configured grants for the UE;
receive configuration information for the one or more configured grants, wherein the one or more configured grants indicate periodic uplink resources for one or more respective configured grant periods, wherein the periodic uplink resources include transmission occasions allocated for uplink transmissions, and wherein the configuration information indicates at least one configured grant timer value that is associated with at least one configured grant period of the one or more respective configured grant periods and that is based at least in part on the recommendation information;
initiate a first configured grant timer based at least in part on transmission of an uplink message during a first transmission occasion of a set of transmission occasions within a first configured grant period of the at least one configured grant period, wherein a duration of the first configured grant timer is based at least in part on a first configured grant timer value associated with the at least one configured grant timer value; and
transmit, based at least in part on expiration of the first configured grant timer, a retransmission of the uplink message in a subsequent transmission occasion of the set of transmission occasions.

2. The UE of claim 1, wherein the one or more processors are individually or collectively further operable to execute the code to cause the UE to:
transmit a capability message that indicates a capability of the UE to recommend, in the recommendation information, an adjustment to a configured grant timer parameter.

3. The UE of claim 1, wherein, to transmit the message, the one or more processors are individually or collectively operable to execute the code to cause the UE to:
transmit the message via uplink assistance information, uplink control information, or a medium access control-control element (MAC-CE).

4. The UE of claim 1, wherein the one or more processors are individually or collectively further operable to execute the code to cause the UE to:
receive a second message that indicates a request for a recommendation for adjustment to a configured grant timer parameter or indicates a capability of a network entity to adjust a configured grant timer parameter based at least in part on a UE recommendation, and
wherein, to transmit the message, the one or more processors are individually or collectively operable to execute the code to cause the UE to:
transmit the message based at least in part on reception of the second message.

5. The UE of claim 1, wherein the one or more processors are individually or collectively further operable to execute the code to cause the UE to:
receive an acknowledgement message of successful receipt of the recommendation information.

6. The UE of claim 1, wherein the at least one configured grant timer value comprises a maximum configured grant timer value and a minimum timer value, and wherein the one or more processors are individually or collectively further operable to execute the code to cause the UE to:
select the first configured grant timer value, wherein the first configured grant timer value is less than or equal to the maximum configured grant timer value and greater than or equal to the minimum timer value; and
transmit a second message that indicates second recommendation information, wherein the second recommendation information comprises the first configured grant timer value.

7. The UE of claim 1, wherein the one or more processors are individually or collectively further operable to execute the code to cause the UE to:
transmit a second message that comprises one or more indications of one or more performance indicators associated with the UE.

8. The UE of claim 1, wherein the one or more processors are individually or collectively further operable to execute the code to cause the UE to:
transmit, based at least in part on one or more performance indicators failing to satisfy a performance threshold, a second message that indicates second recommendation information, wherein the second recommendation information comprises one or more default configured grant timer parameter values.

9. The UE of claim 1, wherein, to transmit the message, the one or more processors are individually or collectively operable to execute the code to cause the UE to:
transmit the message based at least in part on a performance indicator failing to satisfy a performance threshold.

10. The UE of claim 1, wherein the one or more processors are individually or collectively further operable to execute the code to cause the UE to:
generate, using a machine learning model and based at least in part on one or more performance indicators associated with the UE, the recommendation information.

11. The UE of claim 1, wherein the configuration information indicates a prohibit timer value that indicates a time duration to delay a subsequent request for adjustment to a configured grant timer parameter.

12. The UE of claim 1, wherein the recommendation information comprises one or more configured grant timer parameter values, and
wherein the message comprises indications of which of the one or more configured grant timer parameter values are associated with which of the one or more configured grants.

13. The UE of claim 1, wherein the recommendation information comprises an indication that a configured grant timer for an associated configured grant is to be disabled, an indication of whether to enable or disable both a configured grant timer for an associated configured grant and a hybrid automatic repeat request (HARQ) retransmission timer, or a combination thereof.

14. The UE of claim 1, wherein the message comprises an indication of a quantity of hybrid automatic repeat request (HARQ) processes for which at least one configured grant timer parameter value indicated by the recommendation information is to be maintained.

15. The UE of claim 1, wherein the subsequent transmission occasion aligns with the expiration of the first configured grant timer.

16. The UE of claim 1, wherein the first configured grant timer comprises a configured grant timer or a configured grant retransmission timer.

17. A network entity, comprising:
one or more memories storing processor-executable code; and
one or more processors coupled with the one or more memories and individually or collectively operable to execute the code to cause the network entity to:
receive a message that indicates recommendation information for one or more configured grants for a user equipment (UE);
generate configuration information for the one or more configured grants, wherein the one or more configured grants indicate periodic uplink resources for one or more respective configured grant periods, and wherein the periodic uplink resources include transmission occasions allocated for uplink transmissions;
adjust, based at least in part on the recommendation information, at least one configured grant timer value of at least one respective configured grant timer, wherein the at least one respective configured grant timer is associated with at least one configured grant of the one or more configured grants; and
transmit the configuration information for the one or more configured grants.

18. The network entity of claim 17, wherein the one or more processors are individually or collectively further operable to execute the code to cause the network entity to:
transmit a capability message that indicates a capability of the network entity to adjust a configured grant timer parameter based at least in part on a UE recommendation.

19. The network entity of claim 17, wherein, to receive the message, the one or more processors are individually or collectively operable to execute the code to cause the network entity to:
receive the message via uplink assistance information, uplink control information, or a medium access control-control element (MAC-CE).

20. The network entity of claim 17, wherein, to receive the message, the one or more processors are individually or collectively operable to execute the code to cause the network entity to:
transmit a second message that indicates a request for a recommendation for adjustment to a configured grant timer parameter or indicates a capability to adjust a configured grant timer parameter based at least in part on a UE recommendation, and
wherein, to receive the message, the one or more processors are individually or collectively operable to execute the code to cause the network entity to:
receive the message based at least in part on transmission of the second message.

21. The network entity of claim 17, wherein the one or more processors are individually or collectively further operable to execute the code to cause the network entity to:
transmit, based at least in part on reception of the message that indicates the recommendation information, an acknowledgement message of successful receipt of the recommendation information.

22. The network entity of claim 17, wherein the at least one configured grant timer value comprises a maximum configured grant timer value and a minimum timer value, and
wherein the one or more processors are individually or collectively further operable to execute the code to cause the network entity to:
receive a second message that indicates second recommendation information, wherein the second recommendation information comprises a configured grant timer parameter value that is less than or equal to the maximum configured grant timer value and greater than or equal to the minimum timer value.

23. The network entity of claim 17, wherein the one or more processors are individually or collectively further operable to execute the code to cause the network entity to:
receive a second message comprising one or more indications of one or more performance indicators associated with the UE; and
adjust, based at least in part on at least one of the one or more performance indicators failing to satisfy a performance threshold, a configured grant timer value of at least one configured grant timer associated with at least one of the one or more configured grants to a default configured grant timer value.

24. The network entity of claim 17, wherein the configuration information indicates a prohibit timer value that indicates a time duration for the UE to delay transmission of a subsequent request for adjustment to a configured grant timer parameter.

25. The network entity of claim 17, wherein the recommendation information comprises one or more configured grant timer parameter values, and
wherein the message comprises indications of which of the one or more configured grant timer parameter values are associated with which of the one or more configured grants.

26. The network entity of claim 17, wherein the recommendation information comprises an indication that a configured grant timer for an associated configured grant is to be disabled, an indication of whether to enable or disable both a configured grant timer for an associated configured grant and a hybrid automatic repeat request (HARQ) retransmission timer, or a combination thereof.

27. The network entity of claim 17, wherein the message comprises an indication of a quantity of hybrid automatic repeat request (HARQ) processes for which at least one configured grant timer parameter value indicated by the recommendation information is to be maintained.

28. A method for wireless communications by a user equipment (UE), comprising:
transmitting a message that indicates recommendation information for one or more configured grants for the UE;
receiving configuration information for the one or more configured grants, wherein the one or more configured grants indicate periodic uplink resources for one or more respective configured grant periods, wherein the periodic uplink resources include transmission occasions allocated for uplink transmissions, and wherein the configuration information indicates at least one configured grant timer value that is associated with at least one configured grant period of the one or more respective configured grant periods and that is based at least in part on the recommendation information;
initiating a first configured grant timer based at least in part on transmission of an uplink message during a first transmission occasion of a set of transmission occasions within a first configured grant period of the at least one configured grant period, wherein a duration of the first configured grant timer is based at least in part on a first configured grant timer value associated with the at least one configured grant timer value; and
transmitting, based at least in part on expiration of the first configured grant timer, a retransmission of the uplink message in a subsequent transmission occasion of the set of transmission occasions.

29. The method of claim 28, further comprising:
transmitting a capability message indicating a capability of the UE to recommend, in the recommendation information, an adjustment to a configured grant timer parameter.

30. A method for wireless communications by a network entity, comprising:
receiving a message indicating recommendation information for one or more configured grants for a user equipment (UE);
generating configuration information for the one or more configured grants, wherein the one or more configured grants indicate periodic uplink resources for one or more respective configured grant periods, and wherein the periodic uplink resources include transmission occasions allocated for uplink transmissions;
adjusting, based at least in part on the recommendation information, at least one configured grant timer value of at least one respective configured grant timer, wherein the at least one respective configured grant timer is associated with at least one configured grant of the one or more configured grants; and
transmitting the configuration information for the one or more configured grants.
